(19) United States
(12) Patent Application Publication
(10) Pub. No.: US 2003/0081013 A1
(43) Pub. Date: May 1, 2003

(54) Systems and methods for controlling the presentation of a hierarchical arrangement of items in a window of a graphical user interface

(76) Inventors: Kram Henry Allen, Meridian, ID (US); Linn James Kropf, Boise, ID (US); Clifford Lee Coppinger, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/002,258

(22) Filed: Nov. 1, 2001

(51) Int. Cl. G09G 5/00

(52) U.S. Cl. 345/853

(57) ABSTRACT

Systems and methods for controlling the presentation of a hierarchical arrangement of items in a window of a graphical user interface are provided. One embodiment is a method for controlling the presentation of a hierarchical arrangement of items in a window of a graphical user interface. At least one of the items in the hierarchical arrangement has one or more related sub-items. Briefly described, one such method comprises the steps of: determining when a cursor is moved over one of the items; and if the one of the items has one or more related sub-items, displaying a first preview window comprising the one or more related sub-items.

### TECHNICAL FIELD

The present invention is generally related to the presentation of hierarchical arrangements of items on a graphical user interface and, more particularly, is related to systems and methods for controlling the presentation of a hierarchical arrangement of items in a window of a graphical user interface.

### BACKGROUND OF THE INVENTION

Currently, there are a number of computer applications that display a hierarchical arrangement of items on a display device. Typically, such computer applications also provide a graphical user interface by which a user may interact with the application by manipulating a cursor and engaging input buttons. For example, a user may use a mouse having one or more buttons to manipulate the cursor and interact with the computer application.

When such computer applications are launched, the hierarchical list of items is displayed such that parent items are displayed, but sub-items, or child items, associated with the parent items are not visible. In order to view the child items, a user typically must expand the parent item. The user may expand the list and thereby display child items related to a particular parent item by moving the cursor over the parent item and double-clicking an input button, such as a mouse button. The user may also expand the list by moving the cursor over a virtual button associated with the parent item and clicking a the virtual button. In a similar manner, the list may be returned to the original state by collapsing the particular parent item so the child items are no longer displayed.

These methods of expanding and collapsing a hierarchical list to view the child items associated with a parent item may be problematic. For example, in order to view the child items, the user typically must expand the list by clicking the virtual button or double-clicking the parent item. Thus, if the user determines that the incorrect parent item has been expanded, the user must collapse the parent item and then expand another parent item. This problem may be heightened in complex hierarchical arrangements where there are many levels of sub-items.

Thus, there is a need in the industry for improved systems and methods for controlling the presentation of a hierarchical arrangement of items in a window of a graphical user interface.

### SUMMARY OF THE INVENTION

The present invention provides systems and methods for controlling the presentation of a hierarchical arrangement of items in a window of a graphical user interface.

In this regard, one such method comprises the steps of: determining when a cursor is moved over one of the items; and if the one of the items has one or more related sub-items, displaying a first preview window comprising the one or more related sub-items.

Another embodiment is a system for controlling the presentation of a hierarchical arrangement of items in a window of a graphical user interface. At least one of the items in the hierarchical arrangement has one or more related sub-items. Briefly described, in architecture, the system may comprise logic, a display device, a cursor manipulation device, and a processing device. The logic is configured to: determine when a cursor is moved over one of the items; and if the one of the items has one or more related sub-items, display a first preview window comprising the one or more related sub-items. The display device is configured to support the graphical user interface. The cursor manipulation device is configured to cooperate with the application and for manipulating the cursor with respect to the graphical user interface. The processing device is configured to implement the logic and the application.

The present invention may also be viewed as a computer program, which is embodied in a computer-readable medium, for controlling the presentation of a hierarchical arrangement of items in a window of a graphical user interface. At least one of the items has one or more related sub-items. Briefly described, the computer program comprises logic configured to: determine when a cursor is moved over one of the items; and if the one of the items has one or more related sub-items, display a first preview window comprising the one or more related sub-items.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment of a system of the present invention that includes a computing device having a hierarchical list control module for controlling the hierarchical arrangement of items in a window of a graphical user interface.

FIG. 2 is a screen shot of a window generated by an application that is implementing the hierarchical list control module of FIG. 1.

FIG. 3 is a screen shot of the window of FIG. 2, in which a button associated with the “My Computer” item has been clicked, thereby causing the “My Computer” item to be expanded and display the related sub-items.

FIG. 4 is a screen shot of the window of FIG. 2, in which a cursor has been moved over the “My Computer” item, thereby causing a preview window to be displayed that comprises the related sub-items.

FIG. 5 is a screen shot of the window of FIG. 4, in which the cursor has been moved over the “Sys on ‘Fs1’(F:)” item, thereby causing a preview window to be displayed that comprises the related sub-items.

FIG. 6 is a flow chart illustrating the functionality, architecture, and/or operation of an embodiment of the hierarchical list control module of FIG. 1.

### DETAILED DESCRIPTION

I. Overview

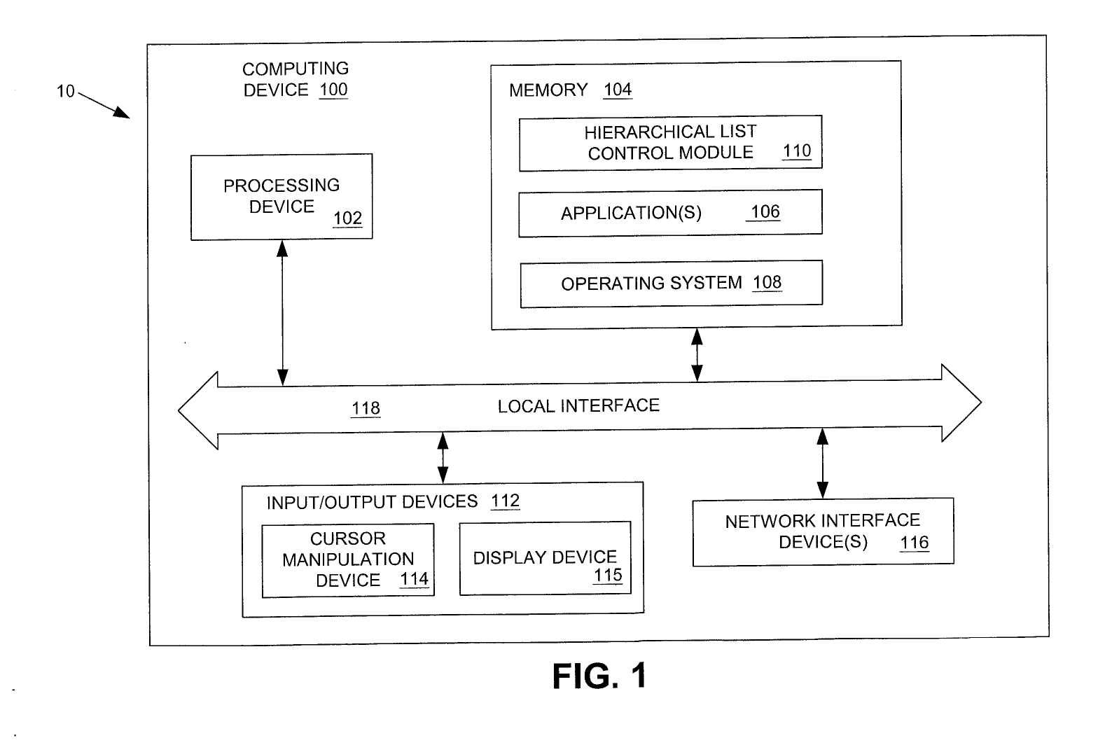

FIG. 1 is a block diagram of a system 10 of the present invention that includes a computing device 100 in which a hierarchical list control module 110 may be implemented. In general, hierarchical list control module 110 controls the presentation of a hierarchical arrangement of items in a window of a graphical user interface. Hierarchical list control module 110 enables a user to preview the sub-items associated with an item without actually expanding the item by double-clicking on the item or clicking on a button associated with the item. Rather, hierarchical list control module 110 enables a user to preview the sub-items in a preview window by moving a cursor over the item.

II. Computing Device

Referring to FIG. 1, computing device 100 may comprise a processing device 102, memory 104, one or more input/out devices 112, and one or more network interface devices 116 interconnected via a local interface 118. Memory 104 may comprise an operating system 108, one or more applications 106, and a hierarchical list control module 110. One of ordinary skill in the art will appreciate that hierarchical list control module 110 may be implemented in any of a variety of types of computing devices that include a display device 115 and a cursor manipulation device 114. For example, display device 115 may comprise any of the following (or other) types of devices: a computer monitor, a liquid crystal display (LCD), a plasma-based display, an LED-based display, a touch-sensitive screen, such as those implemented in portable computing devices (e.g., a personal digital assistant (PDA)), and any other known or future display device, regardless of the underlying display technology. Cursor manipulation device 114 may comprise any input device configured to cooperate with an application 106 and/or operating system 108 and manipulate a cursor displayed on the display device 115. For example, cursor manipulation device 114 may comprise a mouse, a trackball, a set of navigation keys (e.g., arrow keys), and a joystick stick, to name a few.

Depending on the particular configuration of cursor manipulation device 114 and display device 115, computing device 100 may comprise, for example, a personal computer (PC), laptop, server, workstation, and a portable computing device, such as a personal digital assistant (PDA), to name a few. Furthermore, computing device 100 may comprise additional components not illustrated in FIG. 1. In other embodiments, computing device 100 may not include all of the components illustrated in FIG. 1.

Referring again to FIG. 1, the various components of computing device 100 will be described. Local interface 118 may be, for example but not limited to, one or more buses or other wired or wireless connections. Local interface 118 may comprise additional elements, which are omitted for simplicity, such as controllers, buffers (caches), drivers, repeaters, and receivers, to enable communications. Further, local interface 118 may include address, control, and/or data connections to enable appropriate communications among processing device 102, memory 104, input/output devices 112, network interface device 116, and any other components included in computing device 100.

Memory 104 may include any one or combination of volatile memory elements (e.g., random access memory (RAM, such as DRAM, SRAM, SDRAM, etc.)) and nonvolatile memory elements (e.g., ROM, hard drive, tape, CDROM, etc.). Memory 104 may incorporate electronic, magnetic, optical, and/or other types of storage media. Memory 104 may also have a distributed architecture, where various components are situated remote from one another, but may be accessed by the processing device 102. As stated above, memory 104 may comprise an operating system 108, one or more applications 106, and a hierarchical list control module 110.

Again, depending on the particular configuration and/or type of computing device 100 in which hierarchical list control module 110 is implemented, operating system 108 may be any of the following, or other, operating systems: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as PalmOS available from Palm Computing, Inc. and Windows CE available from Microsoft Corporation). Operating system 108 essentially controls the execution of other computer programs, such as the applications 106 and hierarchical list control module 110, and provides scheduling, input-output control, file and data management, memory management, and communication control and related services.

Processing device 102 may be a hardware device for executing software located in memory 104. Processing device 102 may be any custom made or commercially available processor, a central processing unit (CPU), a semiconductor based microprocessor (in the form of a microchip or chip set), a macroprocessor, or generally any device for executing software instructions.

Network interface device(s) 116 may be any device configured to facilitate communication between computing device 100 and a communication network, such as a public or private packet-switched or other data network including the Internet, a circuit switched network, such as the public switched telephone network, a wireless network, an optical network, or any other desired communications infrastructure.

Input/output devices 112 may comprise any device configured to communicate with local interface 118. One of ordinary skill in the art will appreciate that, depending on the configuration and/or type of computing device, input/output devices 112 may include any of the following, or other, devices: a keyboard, a serial port, a parallel port, a printer, speakers, a microphone, a flatbed scanner, etc.

III. Hierarchical List Control Module

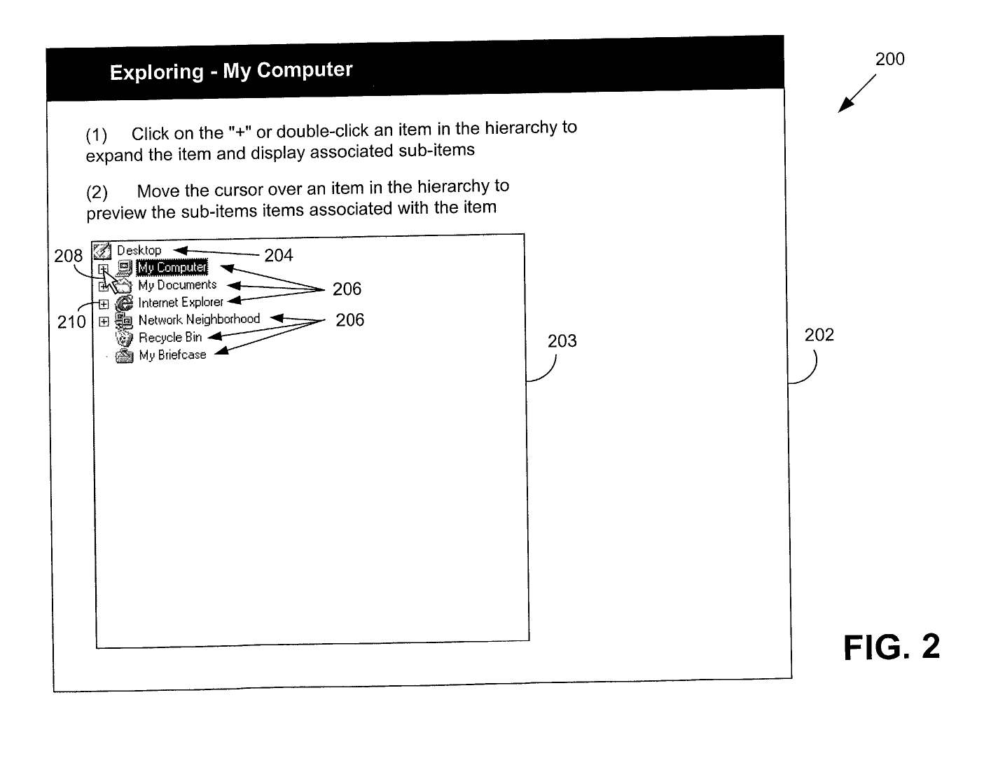

Referring to FIGS. 2-6, an embodiment of hierarchical list control module 110 will be described. Hierarchical list control module 110 may be implemented in hardware, software, firmware, or a combination thereof. As illustrated in FIG. 1, in one of a number of possible embodiments, hierarchical list control module 110 may be implemented in software or firmware that is stored in memory 104 and executed by processing device 102 or any other suitable instruction execution system. If implemented in hardware, as in alternative embodiments, hierarchical list control module 110 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As stated above, hierarchical list control module 110 may be implemented in any of a variety of types of computing devices that include a display device 115 and a cursor manipulation device 114. In general, hierarchical list control module 110 controls the presentation of a hierarchical arrangement of items in a window of a graphical user interface displayed on display device 115. Hierarchical list control module 110 enables a user to preview the sub-items in a preview window (without actually expanding the item) by manipulating a cursor over the item.

In certain embodiments, hierarchical list control module 110 may be implemented as a function that may be called by operating system 108 and an application 106. For example, an application 106 configured to manage the files on computing device 100, such as Windows Explorer, may call hierarchical list control module 110 to display a hierarchical arrangement of the items and sub-items (e.g., files, directories, folders, etc.) located in memory 104. In this manner, the functionality of hierarchical list control module 110 may be shared by various applications 106. In alternative embodiments, the functionality of hierarchical list control module 110 may be seamlessly implemented within an application 106.

In further embodiments, hierarchical list control module 110 may be implemented within operating system 108 as, for example, a dynamic-link library (DLL). For instance, a Windows-based operating system, may include a set of “common controls,” which are a set of windows that are implemented by a common control library (e.g., a DLL). The common control is a child window that an application 106 uses in conjunction with another window to perform input/output tasks. The common controls may belong to a window class defined in the common control DLL. The window class and the corresponding window procedure define the properties, appearance, and behavior of the control.

Each type of common control may have a set of control styles that a software developer may use to vary the appearance and behavior of the control The common control library may also include a set of control styles that apply to two or more types of common controls. Because common controls are windows, an application 106 may manipulate them by using messages. In addition, the window class of each common control supports a set of control-specific messages that an application may use to manipulate the control. An application 106 may use any of the message sending or posting functions to pass messages to the control within operating system 108. Some common controls also have a set of macros that an application 106 may use instead of the sending or posting functions. The macros are typically easier to use than the functions.

As stated above, common controls are child windows, which may send notification messages to the parent window when events, such as input from the user, occur in the control. The application 106 may use these notification messages to determine what action the user wants it to take.

One type of common control implemented within such operating systems is a “tree-view control.” One of ordinary skill in the art will appreciate that hierarchical list control module 110 may be implemented within a tree-view control in operating system 108. Furthermore, hierarchical list control module 110 may be implemented as a tree-view control within an application 106.

A tree-view control is a window that displays a hierarchical list of items, such as the headings in a document, the entries in an index, or the files and directories in memory. Each item consists of a label and an optional bitmapped image and virtual button. Each item can have a list of sub-items associated with it. A user may expand and collapse the associated list of sub-items by: (1) manipulating a cursor over the item or bitmapped image and double-clicking; and (2) manipulating the cursor over the virtual button and single-clicking.

Applications 106 may create an application-specific tree-view control by initiating a particular window class associated with the operating system. The class is registered when the common control DLL is loaded. To ensure that the appropriate DLL is loaded, application 106 may include a function call in the application. After creating a tree-view control, an application may add, remove, arrange, or otherwise manipulate items by sending messages to the control. Each message has one or more corresponding macros that may be used instead of sending the message explicitly.

Tree-view styles may be used to control the appearance of the tree-view control. For instance, the application 106 may set the initial styles when the tree-view control is created. The application 106 may retrieve and/or change the styles after creating the tree-view control by using predefined function calls recognized by the operating system 108. One predefined style function call may be used to enhance the graphic representation of the hierarchy of a tree-view control by drawing lines that link child items to their parent item. As mentioned above, another function call may expand and/or collapse a parent item's list of child items by double-clicking the parent item. Yet another function call may be used to add the virtual button to the left side of each parent item. The user may click the virtual button once instead of double-clicking the parent item to expand and collapse the child. Yet another function call may be used to enable the user to edit the text labels of the tree-view items.

Any item in a tree-view control can have a list of sub-items, or child items, associated with it. An item that has one or more child items is called a parent item. A child item is displayed below its parent item and is indented to indicate that it is subordinate to the parent. An item that has no parent appears at the top of the hierarchy and is called a root item.

At any given time, the state of a parent item's list of child items may be either expanded or collapsed. When the state is expanded, the child items are displayed below the parent item. When it is collapsed, the child items are not displayed. The list automatically toggles between the expanded and collapsed states when the user double-clicks the parent item or, where applicable, the user clicks the button associated with the parent item. An application 106 may expand or collapse the child items by using a predefined message.

A tree-view control sends the parent window a predefined notification message when a parent item's list of child items is about to be expanded or collapsed. The notification gives the application 106 the opportunity to prevent the change or to set any attributes of the parent item that depend on the state of the list of child items. After changing the state of the list, the tree-view control may send the parent window another predefined notification message. When a list of child items is expanded, it may be indented relative to the parent item. Additional information related to Windows-based tree-view controls may be found on the Microsoft Developer Network (MSDN) web site at http://msdn.microsoft.com/library/, the content of which is hereby incorporated by reference in its entirety.

FIGS. 2-5 are screen shots displayed on display device 115 and generated by an application 106, such as Windows Explorer, that is implementing an embodiment of hierarchical list control module 110. Hierarchical list control module 110 controls at least a portion of the functionality for presenting a hierarchical arrangement of items in a window. As illustrated in FIG. 2, the application 106 may generate a parent window 202 on display device 115 in which a child window 203 may be displayed. The child window 203 may display a hierarchical list comprising a root item 204 and one or more parent items 206. Each item in the hierarchical list may include a text label, a bitmapped image associated with the text label, and a virtual button 210. For clarity of presentation, each of the parent items 206 may be linked to the root item 204 using lines.

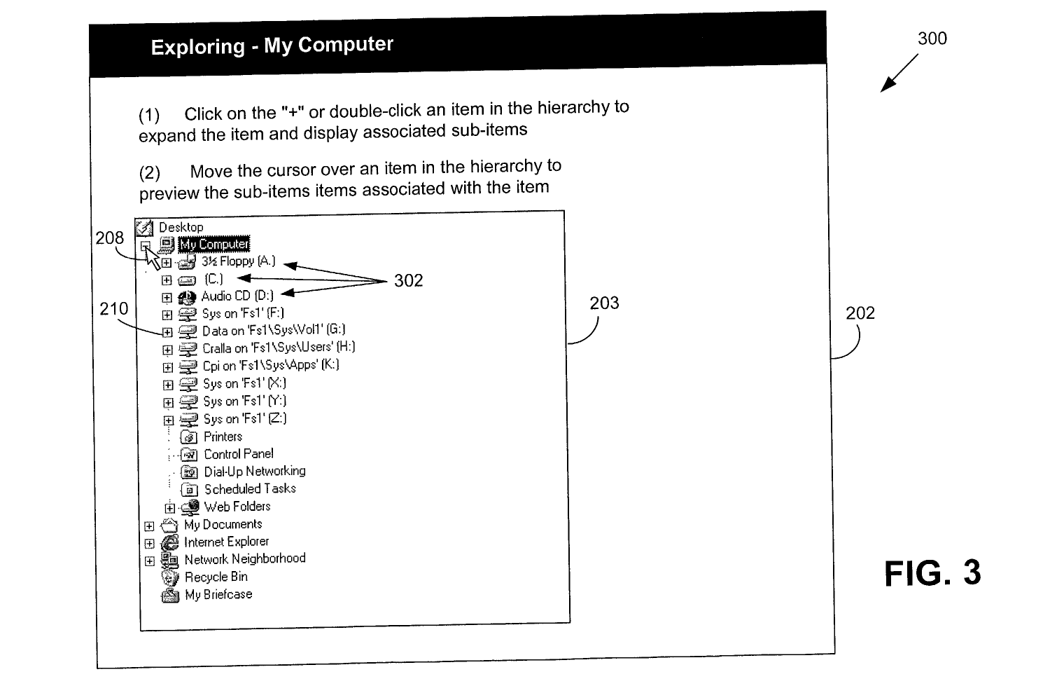

During operation of hierarchical list control module 110, a user may interface with the application 106 by manipulating a cursor 208 within window 202. For example, when the user moves the cursor 208 over the virtual button 210 and clicks a button associated with an input device, the item 206 may be expanded to display the related sub-items 300. As known in the art, the item 206 may also be expanded by moving the cursor 208 over the text label “My Computer” and performing a double-click. FIG. 3 is a screen shot 300 of the window 202 of FIG. 2 in which the virtual button 210 associated with the “My Computer” item 206 has been clicked by a user (or the text label has been double-clicked), thereby causing the “My Computer” item 206 to be expanded and display the related sub-items 302. One of ordinary skill in the art will appreciate that the triggering condition for any of these functions, may be a single-click, a double-click, or any other triggering condition associated with the input device.

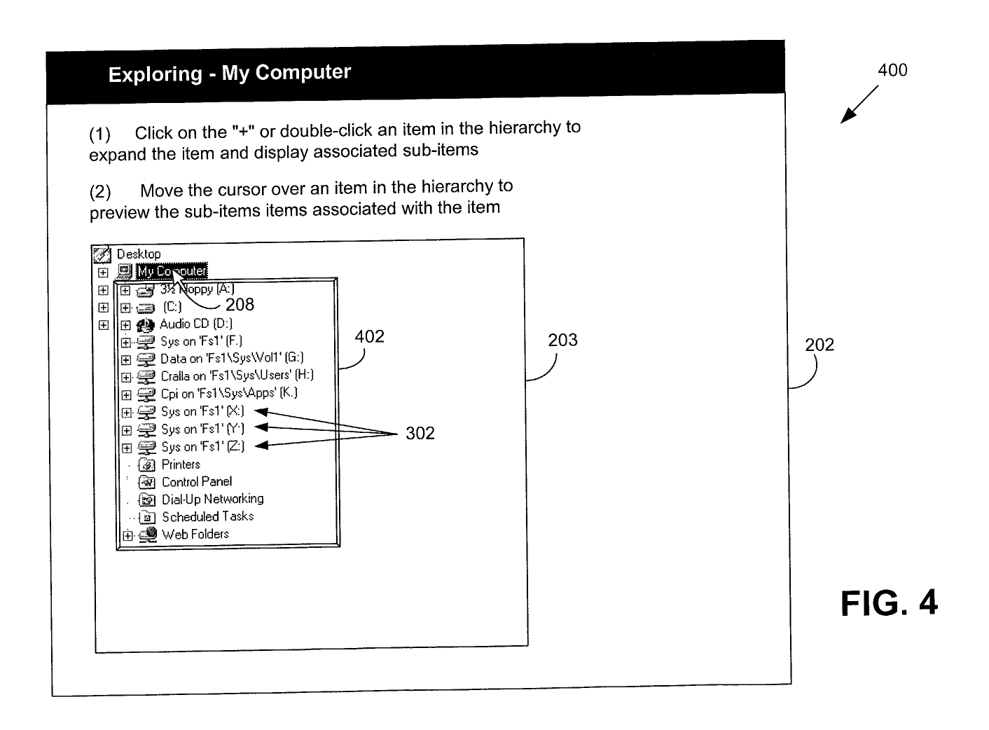

Hierarchical list control module 110 also enables a user to preview the sub-items 302 associated with an item 206 (without actually expanding the item 206) in a preview window 402 by moving the cursor 208 over the item 206. FIG. 4 is a screen shot 400 of the window 202 of FIG. 2 in which the cursor 208 has been moved over the “My Computer” item 206, thereby causing the preview window 402 to be displayed containing a hierarchical list of related sub-items 302. As illustrated in FIG. 4, when the cursor is moved over the item 206, the text label may be highlighted to confirm to the user the current location within the hierarchical list of items.

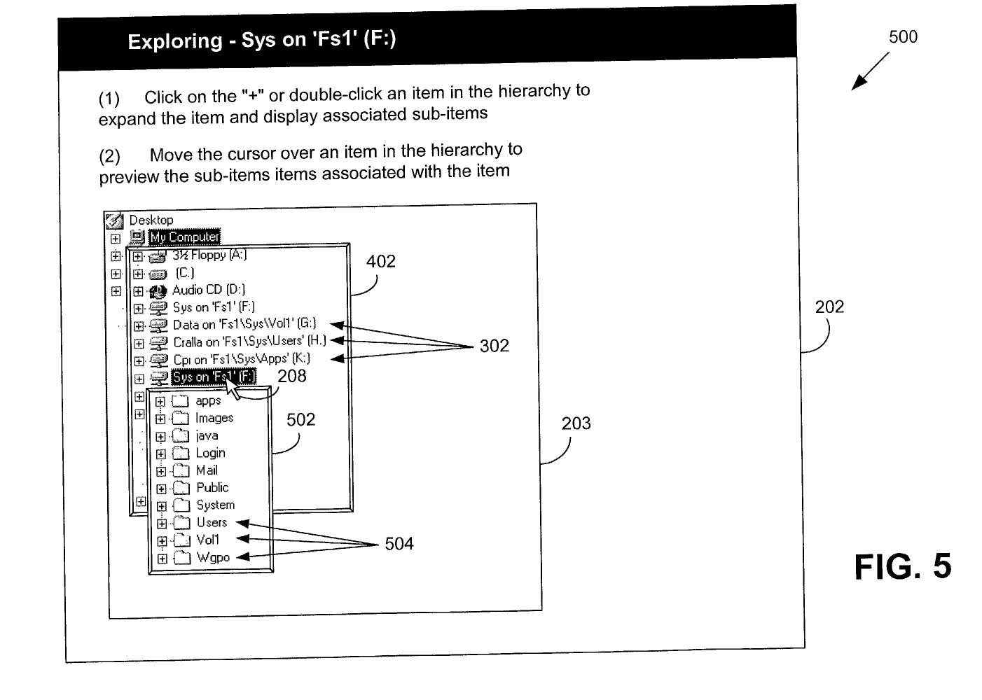

Depending on the hierarchy of the items being presented, hierarchical list control module 110 may also enable a user to preview second-level sub-items 504 related to a particular sub-item 302. For example, as illustrated in FIG. 5, the “My Computer” item 206 may have a sub-item 302 labeled “Sys on ‘Fs1’(F:).” When the user moves the cursor 208 over the sub-item 302, a second preview window 502 may be displayed, which contains one or more second-level sub-items 504. One of ordinary skill in the art will appreciate that hierarchical list control module 110 may be used with any hierarchical list of items regardless of the number of embedded levels.

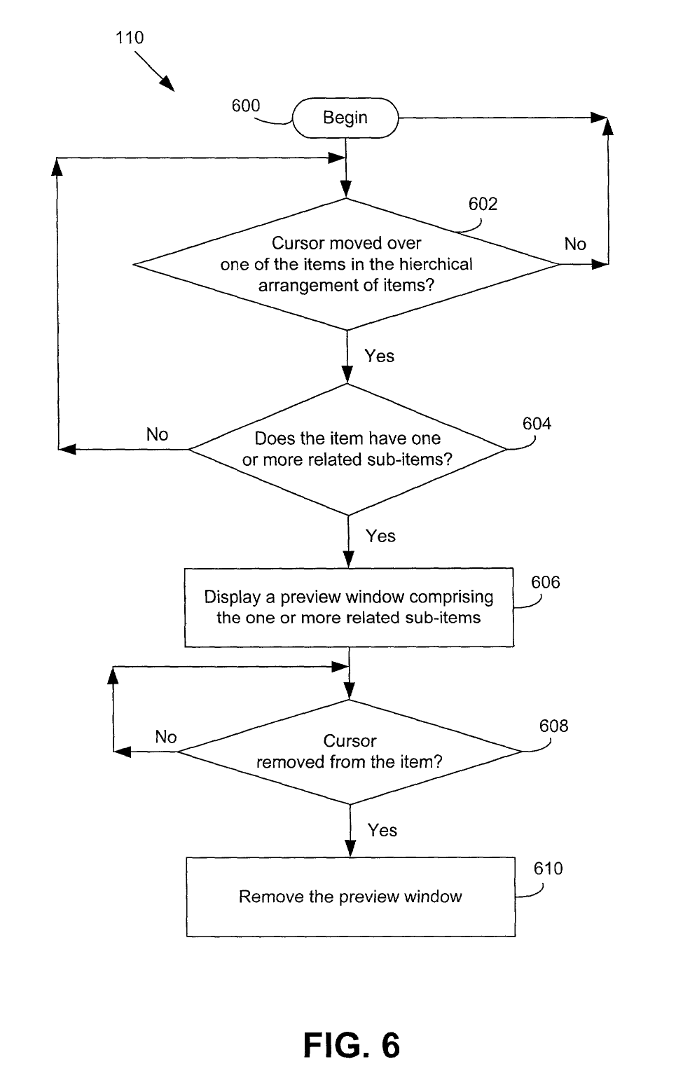

FIG. 6 is a flow chart illustrating the architecture, functionality, and/or operation of an embodiment of hierarchical list control module 110. Hierarchical list control module 110 begins at block 600. As described above, hierarchical list control module 110 may be initiated by a function call from operating system 108 and/or applications 106. In other embodiments, such as where hierarchical list control module 110 is implemented within an application 106, hierarchical list control module 110 may be self-initiating. Therefore, depending on the particular implementation, hierarchical list control module 110 may be initiated in a number of ways.

At decision block 602, hierarchical list control module 110 determines whether a cursor 208 has been moved over one of the items in the hierarchical arrangement of items. If the cursor 208 is over one of the items, at decision block 604, hierarchical list control module 110 determines whether the particular item has one or more related sub-items. If the item does have one or more sub-items, at block 606, hierarchical list control module 110 displays a preview window comprising the one or more related sub-items. As represented by blocks 608 and 610, the preview window will be displayed as long as the cursor 208 is located over the item. As stated above, hierarchical list control module 110 may be configured to support multiple levels of sub-items. In these embodiments, the multiple preview windows may be displayed at the same time to illustrate to the user the current location within the hierarchical list of items.

Any process descriptions or blocks in FIG. 6 should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art.

In addition, hierarchical list control module 110, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of hierarchical list control module 110, particularly, any “described” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

Therefore, having thus described the invention, at least the following is claimed:

1. A method for controlling the presentation of a hierarchical arrangement of items in a window of a graphical user interface, at least one of the items having one or more related sub-items, the method comprising the steps of:
determining when a cursor is moved over one of the items; and
if the one of the items has one or more related sub-items, displaying a first preview window comprising the one or more related sub-items.

2. The method of claim 1, wherein the cursor is manipulated by a mouse.

3. The method of claim 1, further comprising the step of:
when the cursor is moved over one of the items and a button is clicked, expanding the hierarchical arrangement of items in the window to display the one or more related sub-items.

4. The method of claim 3, wherein each of the items comprises a text object and a button and further comprising the step of:
when the cursor is moved over the button associated with one of the items and the button is selected, expanding the hierarchical arrangement of items in the window to display the one or more related sub-items.

5. The method of claim 1, further comprising the steps of:
determining when the cursor is moved over one of the related sub-items in the first preview window; and
if the one of the related sub-items has one or more related second-level sub-items, displaying a second preview window comprising the one or more related second-level sub-items.

6. The method of claim 5, wherein at least a portion of the second preview window is displayed over at least a portion of the first preview window.

7. The method of claim 5, wherein one or more of the related sub-items has one or more related second-level sub-items; and
further comprising the step of:
displaying a second preview window comprising the one or more related sub-items.

8. A system for controlling the presentation of a hierarchical arrangement of items in a window of a graphical user interface, at least one of the items having one or more related sub-items, the system comprising:
logic configured to:
determine when a cursor is moved over one of the items; and
if the one of the items has one or more related sub-items, display a first preview window comprising the one or more related sub-items;
a memory comprising an application supporting a graphical user interface and in which the logic is stored;
a display device configured to support the graphical user interface;
a cursor manipulation device configured to cooperate with the application and for manipulating the cursor with respect to the graphical user interface; and
a processing device configured to implement the logic and the application.

9. The system of claim 8, wherein the logic is embodied in an operating system and initiated by the application.

10. The system of claim 8, wherein the cursor manipulation device is a mouse.

11. The system of claim 8, wherein each of the items comprises a text object and a button.

12. The system of claim 8, wherein the logic is further configured to:
determine when the cursor is moved over one of the related sub-items in the first preview window; and
if the one of the related sub-items has one or more related second-level sub-items, display a second preview window comprising the one or more related second-level sub-items.

13. The system of claim 12, wherein at least a portion of the second preview window is displayed over at least a portion of the first preview window.

14. The system of claim 12, wherein one or more of the related sub-items has one or more related second-level sub-items and the logic is further configured to display a second preview window comprising the one or more related sub-items.

15. A system for controlling the presentation of a hierarchical arrangement of items in a window of a graphical user interface, at least one of the items having one or more related sub-items, the system comprising:
means for determining when a cursor is moved over one of the items; and
a means for displaying a first preview window comprising the one or more related sub-items if the one of the items has one or more related sub-items.

16. The system of claim 15, further comprising a cursor manipulation means for manipulating the cursor with respect to the graphical user interface.

17. The system of claim 15, wherein each of the items comprises a text object and a button.

18. The system of claim 15, wherein:
the means for determining determines when the cursor is moved over one of the related sub-items in the first preview window; and
the means for displaying displays a second preview window comprising the one or more related second-level sub-items if the one of the related sub-items has one or more related second-level sub-items.

19. A computer program, which is embodied in a computer-readable medium, for controlling the presentation of a hierarchical arrangement of items in a window of a graphical user interface, at least one of the items having one or more related sub-items, the computer program:
logic configured to:
determine when a cursor is moved over one of the items; and
if the one of the items has one or more related sub-items, display a first preview window comprising the one or more related sub-items.

20. The computer program of claim 19, wherein the logic is further configured to:
determine when the cursor is moved over one of the related sub-items in the first preview window; and
if the one of the related sub-items has one or more related second-level sub-items, display a second preview window comprising the one or more related second-level sub-items.
